(19) United States
(12) Patent Application Publication
(10) Pub. No.: US 2013/0151325 A1
(43) Pub. Date: Jun. 13, 2013

(54) LOYALTY REWARDS DIRECT PAYMENT AND INCENTIVE METHOD AND SYSTEM

(71) Applicants: Mark Poidomani, (US); Peter Abell, (US)

(72) Inventors: Mark Poidomani, (US); Peter Abell, (US)

(21) Appl. No.: 13/566,812

(22) Filed: Aug. 3, 2012

Related U.S. Application Data
(60) Provisional application No. 61/515,340, filed on Aug. 5, 2011.

(51) Int. Cl. G06Q 30/02

(52) U.S. Cl. CPC G06Q 30/0226
USPC 705/14.27

(57) ABSTRACT

A method and system of facilitating and expediting a Transaction between a Merchant and a Patron of the Merchant is provided. In one embodiment of the invention, a Patron who has previously registered their loyalty account to receive Incentive Rewards for completing the Transaction and to allow the transfer of funds, utilizing an ACH Transaction, from their account to the Merchant's account, can use a single Personal Loyalty Device to expedite, pay for and complete the Transaction and receive Incentive Rewards. According to the invention, after receiving the loyalty account number and, optionally Authentication Information, the Merchant transmits that information and, optionally, Transaction information, to a Rewards Transaction Server who verifies the Transaction, determines Incentive Rewards, generates an Accept Code and sends it to the Merchant, whereupon the Transaction is completed. The Rewards Transaction Server also causes one or more ACH transactions to occur to transfer the funds.

### CROSS REFERENCE TO RELATED PROVISIONAL APPLICATION

This application claims the benefit of U.S. Provisional Patent Application No. 61/515340 filed on Aug. 5, 2011 and entitled Loyalty, Rewards and Payments System.

### BACKGROUND OF THE INVENTION

The present invention is in the technical field of loyalty rewards, coupons and payments. More particularly, the present invention is in the field of consumer loyalty rewards, programs and use of the loyalty rewards program.

This invention allows for the combination of use of traditional merchant loyalty systems, such as printed plastic cards, with the evolving technologies, such as feature phones, smart phones, tablet & computer, electronic display cards, paper cards, and e-book readers and streamlines the point of sale process while providing a convenient payment option.

Currently merchants offer consumers the ability to join Merchants' loyalty programs. Consumers enroll in merchant specific loyalty programs to receive special in store offers, coupons and other incentives for enrolling in the program. After consumers enroll in the loyalty program they usually receive a membership number, often encoded or printed on a card. When the users check out of the merchant's facility, they provide the membership card, or an alternative unique identifier such as a telephone number, and they receive their discounts and optionally rewards points that can be redeemed at a later time for additional discounts and possibly free items.

Although the benefits of the program can be significant, they fall short in that they do not accurately track the buying patterns of the consumers, do not offer the consumer attractive rewards incentives (such as cash back), and do not build any lasting merchant brand loyalty (stickiness), or long lasting product brand loyalty. Such current systems typically present rewards on a “one size fits all” basis rather than specifically addressing the actual behavior of the specific consumer, and do not allow for incremental rewards to be offered or given directly by product manufacturers and marketers.

In addition, when consumers check out, they present both the loyalty card and subsequently another card (debit or credit) or a check or cash in order to pay for the transaction. This part of the check out process is known as the tender process for retailers. It is generally understood in the industry that approximately 25% of the total checkout time for a consumer is spent in the tender process. This is because collecting money and correctly refunding the difference is a predominately a non-automated human action. The rest of the purchase transaction is automated. Because the invention provides for only one account identifier to both activate the loyalty program and pay for the transaction, the tender time for the consumer check out will be reduced.

This invention solves these and many other problems.

### SUMMARY OF THE INVENTION

The present invention is a consumer loyalty system which combines personal loyalty devices (including but not limited to plastic card, paper cards, electronic cards, cell phones, tablet & pad devices, eBook readers, and similar devices known in the art and as further identified in this specification), point of sales terminals, interactive web sites, and loyalty program servers that can all (or some portion of) be interconnected to track and ultimately reward users for purchasing in a particular manner.

According to one embodiment of the invention, the existing loyalty account number is also the payment identification for the consumer and so reduces the tender process time as well as the costs of payment and rewards to both retailer and Consumer Packaged Goods (CPG) manufacturers. The invention is specifically designed to benefit CPG manufacturers, retail merchants, and consumers by offering special programs, financial processing and promotions that are beneficial to all three parties. The invention allows the Program to optionally be offered on a national basis which would provide a national platform with all of the benefits well known to the art. The benefits to the Merchant include decreased check out time, more use of loyalty cards, and a reduced transaction fee. The benefits to the Patron include faster and simpler single swipe checkout and the receipt of Incentive Awards. The CPG supply chain participants can team with a Reward Transaction Server to obtain feedback on how promotional money is spent. The CPG supply chain participants, which can include the Rewards Transactions Server, can directly send Patrons electronic incentives, rewards, and other electronic offers to cut costs and achieve better brand building and reduce costs for incentive programs. The CPG participants can provide rules as to which type of consumer is benefited (those that buy pet food, baby products, or any specific product or category) so that only those targeted consumers receive an offer related to the type of purchases they normally make.

### DEFINITIONS

As used in this specification and in the Claims, the following terms have the definitions given below.

Accept Code(s)—An electronic code or codes generated by a Rewards Transaction Server for verifying that the Rewards Transaction Server has confirmed that the Patron's loyalty account and authentication information is valid and confirming that the Rewards Transaction Server will cause the transfer of funds, utilizing an ACH Transaction, sufficient to cover the Transaction amount from the Patron's Account to the Merchant's account. The Accept Code(s) may also confirm that the Rewards Transaction Server has validated the ACH Transaction and determined what Incentive Reward(s) the Patron is entitled to for the Transaction and that the rewards will be credited to the Patron's loyalty account or transmitted directly to the Patron.

ACH transaction—A payment transaction to or from a Receiver (the User) processed via the ACH Network. The participants in an ACH Transaction are (1) the Originator (the Merchant), (2) the Third-Party Processor, (3) the Originating Depository Financial Institution (ODFI), (4) the ACH Network, (5) the Receiving Depository Financial Institution (RDFI), and (6) the Receiver (the User).

Authentication Information—Any information that uniquely identifies a Patron, including but not limited to any numerical or graphical representation on any analog or digital devices, paper or plastic. The authentication information can be a PIN or other unique digital or manual identifier, a telephone number, a government issued photo ID or any information sufficient to identify the individual as the owner of the loyalty account.

Automatic Clearing House (ACH)—is an electronic network for financial transactions in the United States whose governing rules and regulations are established by NACHA (formerly the National Automated Clearing House Association) and the Federal Reserve which rules and regulations are hereby incorporated in the specification by this reference.

Consumer Packaged Goods—A type of good that is consumed frequently by consumers and Patrons.

Financial Institution—An entity which has arranged to perform ACH Transactions through the ACH members of either the Federal Reserve or any private institution including the Electronic Payments Network.

Incentive Reward(s)—Rewards in any form provided to the Patron participating in a Transaction which are in addition to any rewards the Patron receives from the Merchant's loyalty rewards program or any other source such as coupons, cash vouchers or the like. The Incentive Rewards can be incremental and include individualized rewards and incentives based on the individual Patron's purchasing history. The source of the Incentive Rewards can be the Rewards Transaction Server, an entity contracting with the Rewards Transaction Server to provide such rewards such as a CPG manufacturer, or other marketer, or the Merchant, or any other source working in conjunction with the Rewards Transaction Server or the Merchant.

Incentive Rewards and Payment Program (“Program”)—A program offered to a consumer/customer of a Merchant to register his or her Merchant loyalty account to receive Incentive Rewards and link to his or her bank account to facilitate completion of a Transaction and receive Incentive Rewards (the Program). The Program may be offered by one or more of a Merchant, a Rewards Transaction Server, and a third party marketer. One or more third parties may be enlisted by the Merchant and/or Rewards Transfer Server to implement one or more functions of the Program. For example, such third parties could provide, at the direction of and in coordination with the Merchant and/or Rewards Transaction Server, computer assisted storage, encryption, transmission and report generation services.

Merchant—Any provider of goods or services to a Patron where the Patron has registered for a Program.

Patron—Any person who begins and completes the process of buying the goods, or using the services offered by Merchant, or one who assists or merely accompanies another who purchases the goods or services offered and who has registered for an Incentive Reward and payment program with the Merchant. As used in the specifications and claims, Patron is interchangeable with consumer in the appropriate context of a consumer registered in a Program.

Periodic Transaction File—A file containing the verified information including the particulars of the Transaction to be read at the end of any selected Period. The period can be any configurable transaction period (minute, hour, day, days, week, or month(s)) which conforms to the Merchant and Rewards Transaction Server needs and to ACH transaction criteria. Often the period will be one day. Such files include but are not limited to files stored on servers, or in a cloud structure or any other data storage mechanism that may be known to those skilled in the art.

Personal Loyalty Device—Any device such as a plastic card, paper card, features phone, smart phone, MP3 player, tablet/pad PC, eBook, electronic display card, or any other device which, through electronic or analog means, stores or displays a consumer's or Patron's personal loyalty account number whether these devices display the information via manual methods (viewing the account number on the card and entering a number into the system), automated methods such as a bar code scanning the personal loyalty identification device or contactless communications—such as RFID, NFC, InfraRed, Bluetooth, Zigbee, Wi-Fi, VHF, UHF, HF or LF devices, or any other devices which will be well known to persons skilled in the art.

POS terminal—A point-of-sale (POS) terminal (a computerized replacement for a cash register) is a device that is used to process payment transactions. Generally, a POS terminal has as its core a computer, which is provided with application-specific programs and I/O devices for the particular environment in which it will serve such as magnetic stripe readers, and contact-less readers such as bar code scanners, RFID readers and InfraRed readers. Traditionally POS terminals have been large stand alone units however POS terminals have evolved into virtual terminals embedded into on-line eCommerce applications and shopping carts as well as mobile devices extended with plug-in magnetic stripe readers and software (such as Square) to create a new class of portable POS terminals.

Rewards Transaction Server—Any entity which has made arrangements with a Merchant to receive Patron loyalty and Transaction information from the Merchant and to facilitate (1) the awarding of Incentive Rewards to the Patron and (2) the ACH transfer of funds from a Patron's account to a Merchant's account.

Rules Engine—Configurable rule driven commands performing actions on data in a Database (e.g. buy one get one free, $ off retail price, % off retail price, and other forms of incentives well known to the art).

Transaction—The event where a Patron who has previously registered for an Incentive Rewards and Payment Program interacts with the Merchant at any point of sale location to pay for goods or services the Patron desires to purchase and during which the Patron provides at least his or her loyalty account number to the Merchant.

### DETAILED DESCRIPTION OF THE INVENTION

Many consumers carry a Personal Loyalty Identification Device that is specific to each Merchant. This can be a plastic card, paper card, features phone, smart phone, MP3 player, tablet/pad PC, eBook, electronic display card, or any other device which, through electronic or analog means stores or displays a consumer's personal loyalty account number. The loyalty account has a unique account identifier or number, which can be printed in plain text, printed in a bar code, embossed, or stored in the Personal Loyalty Device.

Consumers generally present their Personal Loyalty Device to the merchant when purchasing goods. The merchant receives the loyalty account number from the Personal Loyalty Device via manual methods (viewing the account number on the card and entering into the Merchant's POS system), automated methods such as bar code scanning the Personal Loyalty Device or entering a code, such as a telephone number which is linked to the account number, and contactless other forms of communicating the number—such as RFID, NFC, InfraRed, Bluetooth, Zigbee, Wi-Fi, VHF, UHF, HF, LF and other methods well know to the art. The personal loyalty identification step can optionally support promotional applications for each merchant.

Optionally, the consumer could carry a single Personal Loyalty Device, which links all of their distinct loyalty programs from all merchants.

The system and method of the invention provide merchants a consumer website where consumers can enroll into the loyalty system and optionally link their other family member's loyalty cards, cell phones and other consumer devices to the same account. Consumers can also establish a loyalty account with a Merchant and enroll the loyalty account in the Program from the website. Consumers can also manage their account information and specify their reward payout methods, and opt in to receive brand and store promotions.

The system and method of the invention can also include kiosks that Merchants place in their stores that allow consumers to enroll in the loyalty program, and manage their loyalty account. Consumers who have loyalty accounts can use these kiosks with their personal loyalty identification device and/or their number to see what discounts they can receive in the store that day. The discounts offered will be unique to each consumer based on previous CPG brand loyalty, CPG directed promotions, merchant directed promotions, buying frequency, and other metrics well know to the art. Where the consumer is a Patron enrolled in the Merchant's Program and the Merchant has provided detailed Transaction to the Rewards Transaction Server, these benefits can be precisely targeted to the Patron.

The system and method of the invention may also include dispersed kiosks (PC's, tablets, stations capable of receiving consumer loyalty number information, and other devices which may be known to the art) that merchants place in their stores that are strategically located near specific sub-departments or categories (such as cereal or cola beverages) within the store. Consumers can visit these kiosks or tablets with their personal loyalty identification device to see what discounts they can receive in that area. The discounts offered will be unique to each consumer based on previous CPG brand loyalty, CPG directed promotions, merchant directed promotions, buying frequency, and other metrics well know to the art. Patrons can receive targeted incentives from these kiosks.

As described above, in one embodiment, the system and method of the invention allow consumers to link a checking or savings account to their loyalty account in order to pay for their purchases and receive Incentive Rewards and thus enroll in the Program. In this embodiment, the system and method of the invention allow for consumer rewards to be targeted to a single unique consumer by linking of the consumer and his or her purchase of a single identifiable item if the consumer uses a loyalty card enrolled in the Program. Such individual targeting is one of the many Incentive Rewards benefits received by a Patron enrolled in the Program. While attempts have been made in the past to link loyalty accounts with consumer bank accounts, those attempts have failed in the market place because of, among other reasons, lack of consumer participation. As previously described the Program of the present invention provides benefits to all parties involved in the process and thus insures the wide adoption and success of the invention without the drawbacks of existing programs.

Consumers and Patrons can choose to have their loyalty rewards points directed to their favorite charity, credit or debit card accounts, checking or savings accounts or other financial accounts such as IRAs or college funds in the form of cash.

In another embodiment, the invention records all transactions during a configurable transaction period (including but not limited to minute, hour, day, week, month or other units of time known in the art) and applies all loyalty points accumulated during the transaction period to the consumers account.

The consumers can choose to have their loyalty points redeemed for cash. Points earned by a Patron redeemed for cash can be processed as ACH transactions at the end of the transaction period. ACH transactions offer all parties (merchant, consumer, CPG) a more cost effective method than typical debit/credit card transactions through existing payment systems such as MasterCard, Visa, Amex, Discover, and the like.

The system and method of the invention preferably record all transactions made by the Patron or consumer. That information can be used to create consumer demographic profiles, brand demographics, purchasing patterns of the consumer and build a database that can be used to drive future promotions. Some of the data captured can be Store level X, Y and Z ring, UPC, product category, department, and other metrics which will be known to the art. For future promotions, the database is driven by a rules engine for the basis of varied promotions. For instance, the system could offer a standard set such as BOGO (buy one get one free), $x off retail price, $ off retail price in addition to loyalty card price; web offer plus tablet PC offer, web offer or tablet PC offer and the like.

Digital promotions can be sent electronically by the system to applications on the Personal Loyalty Devices as coupon image files (including but not limited to JPEG, GIF and other formats known in the art), email or social web applications such as Facebook/Twitter, and in the form of text messages. They can also be sent to a tablet or kiosk in a sub-department when the consumers scan their existing loyalty card bar code or the bar code for that merchant on their personal device such as a smart phone or tablet.

Certain consumer purchases receive points that are credited to the consumers loyalty account. All discounts offered to the consumer are credited to their loyalty account at the time of purchase.

The system and method of selected embodiments of the invention whereby a consumer/Patron can register his or her loyalty account to receive Incentive Rewards and authorize the transfer of funds from his or her personal account to pay for a Transaction by providing only the loyalty account number and the Merchant and Rewards Transaction Server process a Transaction are further described in the following process flows.

### Method and System Flow Process

(1) To make a purchase from a Merchant Patrons access their Personal Loyalty Devices. A Patron can optionally select a loyalty account if his or her device is equipped to do so.

(2) The Patron's Personal Loyalty Device can provide the account number to the merchant POS via traditional contact methods such as magnetic stripe by swiping the loyalty device, or via contact-less means such as barcode scan, Radio Frequency communications, or Infrared communications.

(3) If the account number is invalid, then the Patron is asked to present a new loyalty number and returns to (1).

(4) Optionally, the POS system then prompts the Patron to enter his or her authentication information such as a PIN. After the user enters his or her PIN the POS terminal/system encrypts the PIN using standard POS data encryption techniques that are used for debit cards (e.g. PIN Block, ISO 9546), or proprietary encryption techniques, and sends the information to a Rewards Transaction Server for processing using payment industry standards protocols which are well know to the art such ISO 8583 or other open or proprietary standards. Both of ISO 9546 and ISO 8583 are incorporated herein by this reference.

(5) The Rewards Transaction Server receives the information and validates that the account is a valid account for the merchant. If the account is not valid the Rewards Transaction Server sends back an invalid merchant decline code to the Merchant POS terminal.

(6) If the account is valid then the Rewards Transaction Server validates that the PIN passed in the PIN Block is correct for this account. If the PIN is not correct the Rewards Transaction Server sends back an invalid PIN decline code to the Merchant POS terminal.

(7) If the PIN is correct, the Rewards Transaction Server rates the Transaction based on metrics such as amount, past purchasing behavior, velocity checks, anti-fraud heuristics, credit rating, and other criteria known to the art.

(8) If the Transaction is rated as unacceptable the Rewards Transaction

Server sends back a decline code to the Merchant and the Transaction is cancelled.

(10) If the Transaction is accepted the Rewards Transaction Server (a) saves the transaction to a Periodic Transaction File (for later end of period, e.g. day settlement—see End of Period Settlement Flow Process) and (b) the Rewards Transaction Server sends back an Accept Code to the Merchant and, optionally, the user and the Transaction is completed.

(11) Optionally, the Merchant POS terminal/system sends the Transaction demographics such as account, date, time, product sku codes, quantities, and other selected demographics to the Rewards Transaction Server to build a database of purchasing history for the Patron.

### End of Period Settlement Flow Process

(1) The Rewards Transaction Server reads the Transaction file record by record at the end of a preselected period. The period can be any configurable transaction period (minute, hour, day, days, week, or month(s)), which conforms to the Merchant and Rewards Transaction Server needs and to ACH transaction criteria.

(2) The Rewards Transaction Server looks up the Merchant loyalty program configuration record(s) by using the Merchant ID and Patron account number in the Periodic Transaction file.

(3) Using the merchant loyalty program configuration record(s) the system creates the following outputs:

a. ACH transaction to move the purchase amount less loyalty reward amount from Patron account to Merchant account.

b. ACH transaction to move Transaction service fee from Merchant account to Reward Transaction Server account.

(4) The Rewards Transaction Server sends the ACH transactions to the

Financial Institution that will perform the ACH processing.

(5) The Rewards Transaction Server receives the ACH transfer status report from the Financial Institution and reconciles any ACH exception conditions such as insufficient funds, invalid account, or other exception.

(6) The Rewards Transaction Server receives and processes the ACH transfer status report from the Financial Institution and produces:
a. Summary success reports for each Merchant's accounts
b. Summary error reports for each Merchant's accounts
c. Summary reports for Rewards Transaction Server account
d. Summary reports for the Patron account
e. Summary reports to third party accounts participating in the Program

(7) All successful transactions are flagged as completed in the daily purchase transaction file record

### End User Enrollment Flow Process

(1) The Patron initiates the enrollment process. This may be at the Merchant's website, a third party website which manages the rewards program for the Merchant, a Merchant kiosk in the Merchant's store, or an application running on a computer device.

(2) If the Patron does not have an existing Merchant loyalty account, the Patron is promoted to enter their new account username, password and other personal information such as email, mobile phone number, home address, work address, and such other information as may be requested. After the Patron has entered this information his or her account is created.

(3) After creating a new account as in Step 2 or if the Patron has an existing Merchant loyalty account, the Patron logs into his or her account.

(4) The Patron selects an “add loyalty card” function, which has been provided within the account display.

(5) The Patron is prompted to enter his or her loyalty card number for that Merchant, select a payment transaction PIN or other authentication code and select the desired loyalty rewards program such as cash back, coupons, gift cards, charity, or other offered program.

(6) The Patron then enters his or her bank account information specifically the ABA ROUTING NUMBER and ACCOUNT NUMBER thereby linking that bank account to the loyalty account. This bank account will be used to pay for goods and services that are purchased with the loyalty card at the participating Merchant.

(7) The system validates that the account number is valid for that Merchant using the information entered by the Patron when creating a Merchant loyalty account. Optionally, the system can use a third party identity verification service to validate the Patron by asking the Patron a series of personal questions that only the Patron would know the answers to.

(8) If the Patron has been validated in step (7) the system then instructs the Patron to check his or her on-line bank account/bank statement for two deposit transactions made to the bank account entered in step (6). If the deposit information is not immediately available to the Patron, the Patron can save the completed steps of the process and return to this step once the deposit information is available. Other verification processes are known to the art and are included within the scope of the invention.

(9) The Patron checks his or her on-line bank account/bank statement for the two deposits made in step (8) and enters those deposit values. The system validates that the deposit values entered by the Patron are correct and if so activates the Patron's account. If the values are incorrect the Patron is instructed to correct them or restart the process.

(10) The Patron is now enrolled in the Program and may now purchase goods and services at this Merchant with their loyalty cards and receive Incentive Rewards.

### Merchant Enrollment

(1) The Merchant decides on the Incentive Rewards program(s) to support such as cash back amounts, special incentives for special CPG purchases, frequent buyer program incentives and the like.

(2) The Rewards Transaction Server issues the Merchant an account identified by a merchant ID.

(3) The Incentive Rewards programs are added to the Merchant's account as a series of merchant loyalty program configuration record(s) keyed off the merchant ID.

(4) The Merchant integrates the Rewards Transaction Server payment Application Programming Interface (API) into its existing POS, loyalty system and/or POS payment gateway interface(s) allowing Merchant to process loyalty card payments at the POS.

(5) Optionally, the merchant integrates the purchase transaction demographics Rewards Transaction Server payment API into their existing POS, loyalty system and/or POS payment gateway interface(s).

The present invention accordingly comprises the features of construction, combination and arrangement of elements, as well as the several steps and the relation of one or more of such steps with respect to each of the others, all as exemplified in the above detailed disclosures, and the scope of the invention will be indicated in the claims.

It should be appreciated that the aspects, features and advantages made apparent from the foregoing and the accompanying detailed descriptions are efficiently attained and, since certain changes may be made in the disclosed constructions and processes without departing from the scope and spirit of the invention, it is intended that all matter contained herein and in the accompanying detailed description shall be interpreted as illustrative and not in a limiting sense.

It is also to be understood that the following claims are intended to cover all of the generic and specific features of the invention described is this specification and claims, and all statements of the scope of the invention, which as a matter of language, might be said to fall between those features and statements.

1. A method of facilitating a Transaction, after the Transaction is initiated, between a Merchant and a Patron of the Merchant wherein the Patron has a loyalty account with the Merchant and has previously registered his or her loyalty account to receive one or more Incentive Rewards in connection with completing the Transaction and to allow withdrawal of funds utilizing at least one ACH transaction directly from an account owned by the Patron for transfer to the Merchant, comprising, at the direction of and in coordination with the Merchant, the steps of:
A. Receipt from the Patron of information, said information including at least the Patron's loyalty account number with the Merchant;
B. Verification of the Patron's loyalty;
C. Receipt from the Patron of Authentication Information sufficient to verify that the Patron is the owner of the loyalty account provided in Step A and verified in Step B;
D. Encryption of the loyalty information and the authentication information;
E. Storage of the encrypted information and selected information related to the Transaction on a computer system in a form which can be received, read and processed by a Rewards Transaction Server;
F. Transmission of the encrypted information and selected Transaction information to the Rewards Transaction Server;
G. Receipt of an Accept Code from the Rewards Transaction Server verifying that the Rewards Transaction Server has confirmed that the Patron's loyalty account number and authentication information is valid and that the Rewards Transaction Server will cause the transfer of funds, utilizing at least one ACH transaction, sufficient to cover the Transaction amount from the Patron's Account to the Merchant's account; and
H. Completion of the Transaction with the Patron;
whereby the Patron is awarded one or more Incentive Rewards for the Transaction and, utilizing at least one ACH Transaction, funds representing the Patron's net cost of the Transaction are transferred from the Patron's Account and funds for the Transaction acceptable to the Merchant are credited to the Merchant's account.

2. A method of facilitating a Transaction, after the Transaction is initiated, between a Merchant and a Patron of the Merchant wherein the Patron has a loyalty account with the Merchant and has previously registered his or her loyalty account to receive one or more Incentive Rewards in connection with completing the Transaction and to allow withdrawal of funds utilizing at least one ACH Transaction directly from an account owned by the Patron for transfer to the Merchant, comprising, at the direction of and in coordination with a Rewards Transaction Server, the steps of:
A. Receipt of information from the Merchant, said information including at least the Patron's Merchant loyalty account number and selected Transaction information;
B. Verification that the account is valid for the Merchant and the Patron and generation of one or more Accept Code(s);
C. Saving of the verified information including the particulars of the Transaction to a Periodic Transaction File to be read at the end of a selected Period; and
D. Transmission of at least one of the Accept Code(s) to the Merchant;
whereby the Patron is awarded one or more Incentive Rewards for the Transaction and, utilizing at least one ACH Transaction, funds representing the Patron's net cost of the Transaction are transferred from the Patron's Account and funds for the Transaction acceptable to the Merchant are credited to the Merchant's account.

3. A method of facilitating a Transaction, after the Transaction is initiated, between a Merchant and a Patron of the Merchant wherein the Patron has a loyalty account with the Merchant and has previously registered his or her loyalty account to receive one or more Incentive Rewards in connection with completing the Transaction and to allow withdrawal of funds utilizing at least one ACH Transaction directly from an account owned by the Patron for transfer to the Merchant, comprising, at the direction of and in coordination with the Merchant, the steps of:
A. Receipt from the Patron of information, said information including at least the Patron's loyalty account number with the Merchant;
B. Transmission of at least the Patron's loyalty account information and selected Transaction information to a Rewards Transaction Server;
C. Receipt of an Accept Code from the Rewards Transaction Server;
D. Completion of the Transaction with the Patron;
whereby the Patron is awarded one or more Incentive Rewards for the Transaction and, utilizing at least one ACH Transaction, funds representing the Patron's net cost of the Transaction are transferred from the Patron's Account and funds for the Transaction acceptable to the Merchant are credited to the Merchant's account.

4. The Method according to claim 2 including the following steps after Step D:
E. Reading, at the end of the Period, of the Periodic Transaction File to identify Merchant Transactions;
F. Creation of at least one ACH transaction instruction to result in moving funds from the Patron's account and funds to the Merchant's account;
G. Transmission of the at least one ACH transaction instruction generated in Step F to a Financial Institution which will perform the ACH processing; and
H. Notification of the Merchant of any ACH transaction for the Merchant which has been completed.

5. The Method according to claim 4 including the following step after Step B and before Step C:
B.1. Determining the Incentive Rewards to which the Patron is entitled for the transaction and including that determination in the information to be saved in Step C;
And the following step after Step E and before Step F:
E.1. Reading, at the end of the Period, of the Periodic Transaction File to identify Patron Incentive Rewards and, at least one of crediting the Patron's Incentive Rewards to the Patron's loyalty account, crediting the Patron's account with cash, and providing additional targeted rewards directly to the Patron.

6. The method according to claim 1 wherein the Merchant's POS system is utilized to perform one or more of Steps A, B, C, D, E, F, and G.

7. The method according to claim 3 including the following steps after Step A and before Step B:
A.1. Verification of the Patron's loyalty account by the Merchant; and
A.2. Receipt from the Patron of Authentication Information sufficient to verify that the Patron is the owner of the loyalty account provided in Step A and verified in Step A.1.

8. The method according to claim 7 which includes the following steps after Step A.2. and before Step B:
A.3. Encryption of the loyalty information and the authentication information;
A.4. Storage of the encrypted information and selected information related to the Transaction on a computer system in a form which can be received, read and processed by a Rewards Transaction Server.

9. The method according to claim 3 wherein the Merchant's POS system is utilized to perform at least one of Steps A, B, and C.

10. The method according to claim 4 wherein one or more of the Rewards Transaction Server's computer systems are utilized to perform at least one of steps A, B, C, D, E, F, G, and H.
